(19) United States
(12) Patent Application Publication
(10) Pub. No.: US 2012/0287999 A1
(43) Pub. Date: Nov. 15, 2012

(54) SYNTAX ELEMENT PREDICTION IN ERROR CORRECTION

(75) Inventors: Bin Li, Hefei (CN); Jizheng Xu, Beijing (CN); Feng Wu, Beijing (CN)

(73) Assignee: Microsoft Corporation, Redmond, WA (US)

(21) Appl. No.: 13/104,990

(22) Filed: May 11, 2011

(51) Int. Cl. H04N 7/68; H04N 7/26

(52) U.S. Cl. 375/240.16; 375/E07.125; 375/E07.281

(57) ABSTRACT

Architecture that improves error robustness in video coding and decoding. In particular, this can apply to motion vector prediction (MVP) such as a temporal MVP (TMVP). Flags can be used to indicate the use or non-use of a feature, such as to indicate whether the current slice uses or does not use TMVP, and to indicate in the slice header whether list prediction is allowed or not allowed. A flag can be signaled in sequence parameter set (SPS) or picture parameter set (PPS) as a way to enable an entire sequence to use or not use TMVP. TVMP can also be used to copy all the reference motion information to the current block. To address possible error problems, the full index of the TMVP can be recorded, and temporal information decoding refresh (TIDR) can be inserted into slices periodically.

### BACKGROUND

Video processing (e.g., capture, transmission, and playback) is a rapidly evolving technology given the corresponding increase in high-bandwidth capabilities of wired and wireless communications. Motion vector prediction is utilized heavily in video coding and decoding to provide a more efficient reconstruction of a picture being decoded. Errors can occur due to dropped packets, noise, congestion, etc., which reduce the quality of the resultant reconstruction. Moreover, there can be a cascade effect in the faulty frames such that if one frame fails to be correctly transmitted others frames may be affected as well. Thus, error control and concealment facilitates the quality transmission and reconstruction of video. However, evolving video standards can provide shortfalls in error control and concealment.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture improves error robustness by way of one or more flags that indicate the use or non-use of a feature or capability. In particular, this can apply to motion vector prediction (MVP) such as a temporal MVP (TMVP). In accordance therewith, a flag can be utilized in a slice header to indicate whether the current slice uses or does not use TMVP. Thus, the decoder only needs to wait one slice to recover from failure of entropy decoding. Another use of a flag can be to indicate in the slice header whether list prediction (e.g., list 1) is allowed or not allowed. A flag can also be signaled in sequence parameter set (SPS) or picture parameter set (PPS) as a way to enable the entire sequence to use or not use TMVP.

TVMP can also be used to copy all the reference motion information to the current block. To address possible error problems, the full index of the TMVP can be recorded, and temporal decoding refresh can be inserted into slices periodically.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a video error correction system in accordance with the disclosed architecture.

FIG. 2 illustrates an alternative embodiment of a system that includes slice insertion for error management.

FIG. 3 illustrates an exemplary slice level sequence of macroblocks and a slice header into which one or more flags can be inserted and operated.

FIG. 4 illustrates a system of motion vectors that can be employed relative to a basic coding unit for prediction in video processing.

FIG. 5 illustrates an alternative solution to error correction for motion vector prediction.

FIG. 6 illustrates a video error correction method in accordance with the disclosed architecture.

FIG. 7 illustrates further aspects of the method of FIG. 6.

FIG. 8 illustrates a block diagram of a computing system that can execute motion vector prediction in accordance with the disclosed architecture.

### DETAILED DESCRIPTION

In the current video compression standards under development (e.g., TMuC (test model under consideration) 0.9 (also called high efficiency vector coding (HEVC) test model (HM) 1.0), and HM 2.0), motion vector prediction (MVP) (e.g., temporal and spatial) is used. When one frame is lost, the motion vector predictor to the next frame is wrong, and then the number of the motion predictors is wrong. The decoder uses the number of predictors to determine how many symbols to read. If one frame is lost, entropy decoding fails for the following slices, until the next intra-slice.

It is not expected that the loss of a packet will cause the other slices to fail on entropy decoding. If entropy decoding can be performed successfully, the decoder can do error concealment using the entropy decoding result as is designed to do. However, when the entropy decoding fails, the decoder can do nothing but perform frame copying until the next intra-slice.

Thus, in accordance with one aspect of the disclosed architecture, one or more flags are introduced to indicate whether a current slice uses or does not use temporal motion vector prediction. The flag can be sent in a slice header. If one or more slices are inserted periodically in which the temporal motion vector prediction is not adopted, the error propagation is truncated at these slices. Thus, the entropy decoding process will not fail after that slice. In one implementation, only one flag is added in the slice header to improve the error robustness. The decoder only needs to wait one slice, where temporal motion vector prediction is not applied, to recover from entropy decoding failure.

Although a frame that does not employ temporal MVP will be entropy decoded successfully, the frames that reference the frame (does not use temporal MVP) are not processed by a motion vector prediction scaling process. Additionally, the following frames do not use the motion information prior to that frame. Thus, at the encoder side, when two reference frames are used—the encoder inserts two consecutive frames (that do not employ without temporal MVP). The number of frames without TMVP that are inserted depends on the number of reference frames.

Temporal MVP can be scaled according to a picture order count (POC). The POC in the MPEG-4/AVC specification indicates output ordering of a given picture or frame. If the POC of the reference frame, and the POC of the reference frame of the collocated block in the reference frame, can be derived correctly according to the information such as frame number when packet loss exists, entropy decoding will work for the following frames. However, when the POC-deriving process cannot be performed correctly, the scaling process is avoided for the frames that reference the frame without temporal MVP.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

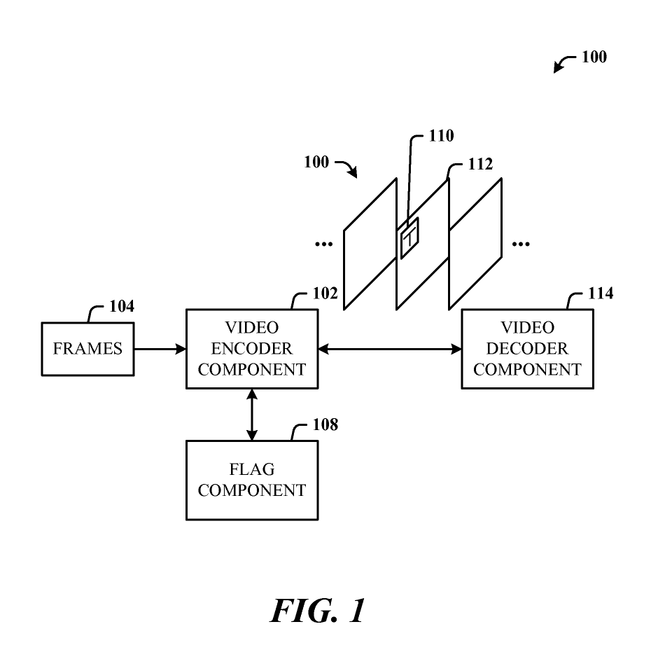

FIG. 1 illustrates a video error correction system 100 in accordance with the disclosed architecture. The system 100 includes a video encoder component 102 that encodes a sequence of video frames 104 as syntax elements in a bit stream 106, and a flag component 108 that employs and operates a flag 110 in a video frame 112 to manage error correction via a motion vector. The motion vector is a temporal motion vector for temporal motion vector prediction. The flag component 108 inserts into and operates the flag 110 in a frame header to indicate that temporal motion vector prediction is enabled or not enabled. The flag 110 can be inserted into and operates in a slice header of the frame 112. The flag 110 can be signaled in a parameter set to enable a sequence to use temporal motion vector prediction. The parameters set can be a sequence parameters set (SPS) or a picture parameter set (PPS), which are described at least in the H.264 specification. An active SPS remains unchanged throughout a coded video sequence and an active PPS remains unchanged within a coded picture. The SPS and PPS structures include information such as picture size, optional coding modes, and macroblock-to-slice group map, for example.

Another problem can occur such that when one frame is lost the decoder may not be able to reconstruct the reference frame list correctly. Block prediction employs two reference frames: List0 for past frames, and List1 for future frames. When the two reference frame lists are identical, List1 prediction in not allowed. The decision on the decoder side to use the List1 prediction may or may not be correct. Thus, a flag can be employed to indicate whether List1 prediction is or is not allowed, and this can be signaled in the slice header as well. The flag component 108 inserts the flag 110 into a frame header to indicate that prediction (e.g., list) for a specific list is enabled or not enabled. The video encoder component 102 encodes an entire index of a motion vector that is a temporal motion vector predictor. The system 100 can further comprise a decoder component 114 that processes the flag 110 and inserts slices to reduce errors when decoding the bit stream.

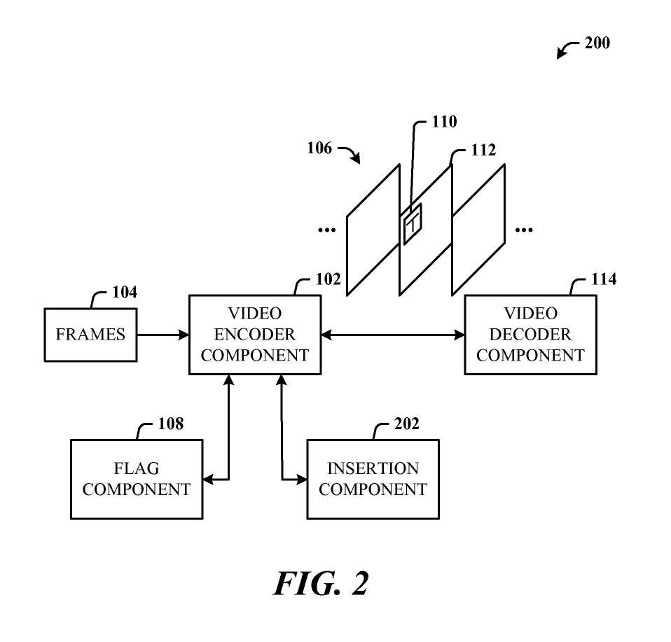

FIG. 2 illustrates an alternative embodiment of a system 200 that includes slice insertion for error management. The system 200 includes the entities and components of the system 100 of FIG. 1, and additionally, an insertion component 202. The insertion component 202 inserts a slice into the bit stream 106 to truncate error propagation. The insertion can be made when temporal motion vector prediction is not used. The insertion component 202 can insert temporal information decoding refresh slices in a frame (e.g., frame 112) to provide a decoding recovery point in the bit stream 106. The insertion component 202 can insert a number of frames without temporal motion vector prediction, where the number of frames correlates (corresponds) to a number of reference frames employed.

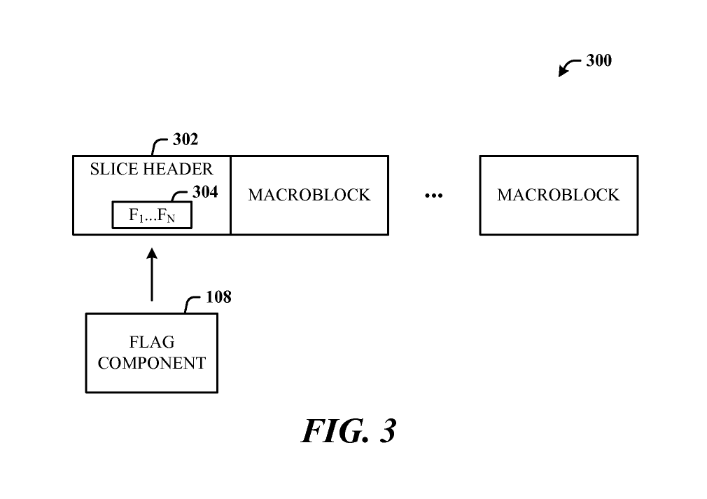

FIG. 3 illustrates an exemplary slice level sequence 300 of macroblocks and a slice header 302 into which one or more flags 304 can be inserted and operated (e.g., toggled).

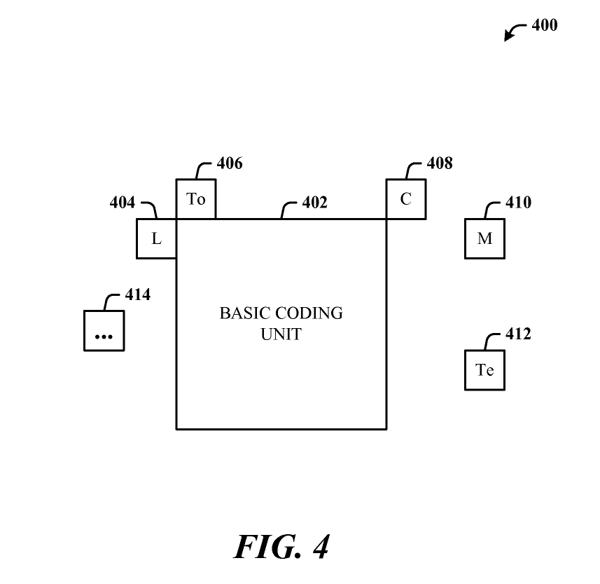

FIG. 4 illustrates a system 400 of motion vectors that can be employed relative to a basic coding unit 402 (e.g., a macroblock of 16×16, 8×8, or the concept of coding unit or prediction unit in HEVC, etc.) for prediction in video processing. The system 400 can include a motion vector 404 for motion from the left (denoted “L”), a motion vector 406 for motion from the top (denoted “To”), a motion vector 408 for motion from a corner (denoted “C”), a motion vector 410 for the median (denoted “M”) of the three prior vectors (404, 406, and 408), a motion vector 412, which is temporal motion vector (denoted “Te”), and other possible vectors 414 as desired. Any one or more of the motion vectors (404, 406, 408, 410, 412, 414) can be a motion vector predictor for the current unit 402 to improve the coding efficiency.

When parsing the bit-stream (e.g., HEVC-high efficiency vector coding), the maximum number of the motion vector predictors of the current unit is known. This maximum number is used when decoding the motion vector prediction index syntax element. If the maximum number is not correct, the decoding process will be wrong.

However, since one of the motion vector predictors is from a temporal collocated block, if the reference frame is lost, the entropy decoding will fail due to the incorrect value of the maximum number of the motion vector predictors. For example, at the encoder, if the maximum value is two and the encoded value is one, one bit will be inserted into the bit-stream.

At the decoder, however, the maximum value may be three because of packet loss. Additionally, the decoder may get more than one bit from the bit-stream for this syntax element. This can lead to all of the following syntax elements to fail decoding. Thus, the following bit-stream will be meaningless. The following frames cannot be entropy decoded until one intra-frame.

This kind of error propagation is not expected. In a former codec (encoder-decoder) scheme, the loss of one slice will not influence the entropy decoding process of the other slices. When the entropy decoding is finished, the decoded information can be used to do the error concealment. If the entropy decoding also fails, the encoder can do nothing but frame copy. Thus, the temporal motion vector predictor from the collocated block is unfriendly to packet loss error.

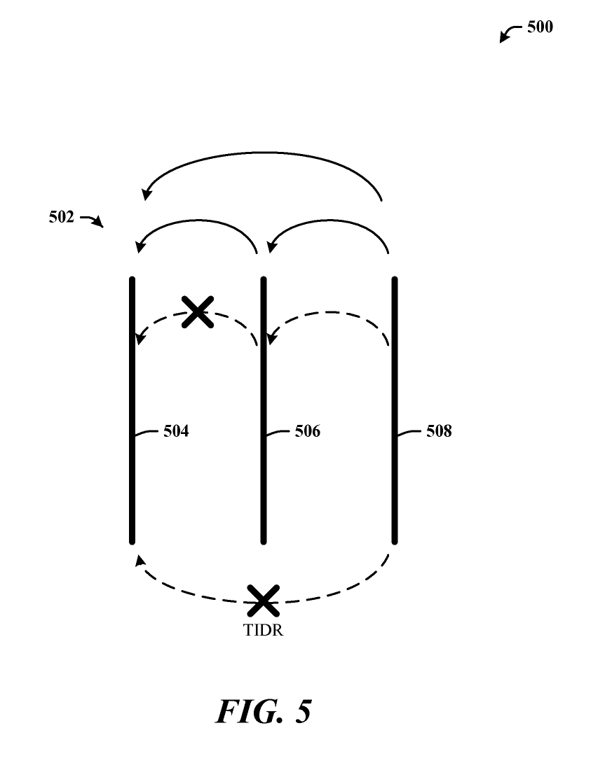

FIG. 5 illustrates an alternative solution 500 to error correction for motion vector prediction. In one implementation, temporal motion vector prediction is introduced to merge mode, which copies all the reference motion information (e.g., inter-prediction direction, reference frame index, the motion vector, etc.) to the current basic coding unit (e.g., macroblock or prediction unit). To address the error robustness problem related to temporal motion vector prediction, two solutions are described: coding the full index of the temporal motion vector predictor, and periodically inserting temporal information decoding refresh slices.

When coding the full index, the maximum value of the motion vector predictor index is not decided by the surrounding information. Both the motion vector predictor index and merge index can be coded by a maximum value independent method. The coding method of the syntax elements, depending on the surrounding motion information, can also be changed. For example, when employing LCEC (low complexity entropy coding) and CABAC (context-adaptive binary arithmetic coding), forms of entropy coding, coding or non-coding of the merge flag is not dependent on the number of merge candidates—this flag is always coded. For LCEC, the adaptive method for combined coding of inter-prediction direction and reference frame index when the surrounding block in merge mode is avoided, as the reference frame index in the merge block may be incorrect. For CABAC, the context model of the merge flag is changed to be independent of the number of merge candidates. For the context model of inter-prediction direction and reference frame index, if the surrounding block is in merge mode, the use of the information of these surrounding blocks is avoided.

With respect to temporal information decoding refresh (TIDR) slices, the TIDR slices do not use temporal information, such as temporal motion prediction and other temporal syntax element prediction. Thus, the TIDR slices can be successfully entropy decoded without temporal motion information from the previous slices. The loss of the previous slices will not affect the entropy decoding. The slices after the TIDR slices cannot use the motion information before the TIDR slice. Additionally, the loss of the previous slices before the TIDR slice do not affect the entropy decoding of the slices after TIDR slices. Thus, a TIDR slice provides an entropy decoding recovery point in the bit-stream. This can be considered a tradeoff between the coding performance and the error robustness.

Shown in FIG. 5, the solution 500 depicts three frames 502: a previous frame 504, a middle frame 506, and a following frame 508. The middle frame 506 is a TDR frame. The solid line arrows indicate whether inter-prediction is allowed, and the dashed line arrows indicate whether temporal syntax element prediction is allowed. Thus, inter-prediction is allowed between the middle frame 506 and the previous frame 504, between the middle frame 506 and the following frame 508, and between the following frame 508 and the previous frame 504. Additionally, temporal syntax element prediction is allowed between the following frame 508 and the middle frame 506, but not allowed between the middle frame 506 and the previous frame 504, and not allowed between the following frame 508 and the previous frame 504.

A TIDR access unit and TIDR picture can be defined as follows. The TIDR access unit is a unit in which the primary coded picture is a TIDR picture. The TIDR picture is a coded picture that does not use temporal information, such as temporal motion prediction and other temporal syntax element prediction. This causes the decoding process to mark all reference pictures (also called frames), except the current TIDR picture, in a way that indicates temporal syntax element prediction is not used for that picture. This marking process occurs for reference pictures immediately before the decoding of the first picture following the current TIDR, with an output order greater than the current TIDR picture. All coded pictures following a TIDR picture in output order can be successfully entropy decoded without temporal syntax element prediction from any pictures that precede the TIDR picture in output order. All coded pictures with output order smaller than the current TIDR are not affected by the deferred marking process.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

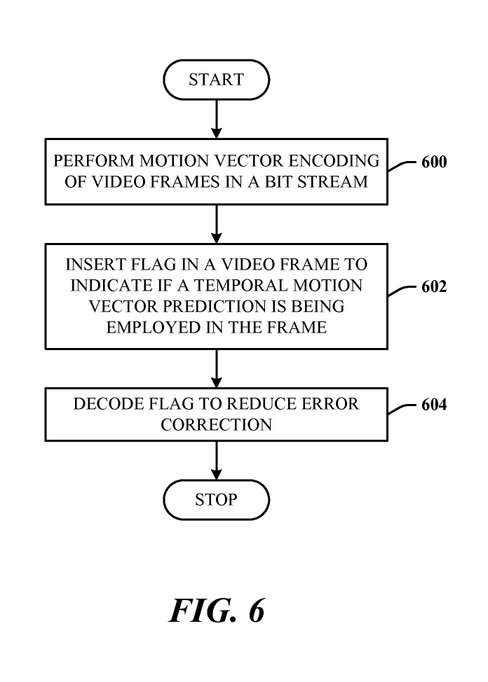

FIG. 6 illustrates a video error correction method in accordance with the disclosed architecture. At 600, motion vector encoding of video frames in a bit stream is performed. At 602, a flag is inserted in a video frame to indicate if a temporal motion vector prediction is being employed in the frame. At 604, the flag is decoded to reduce error correction.

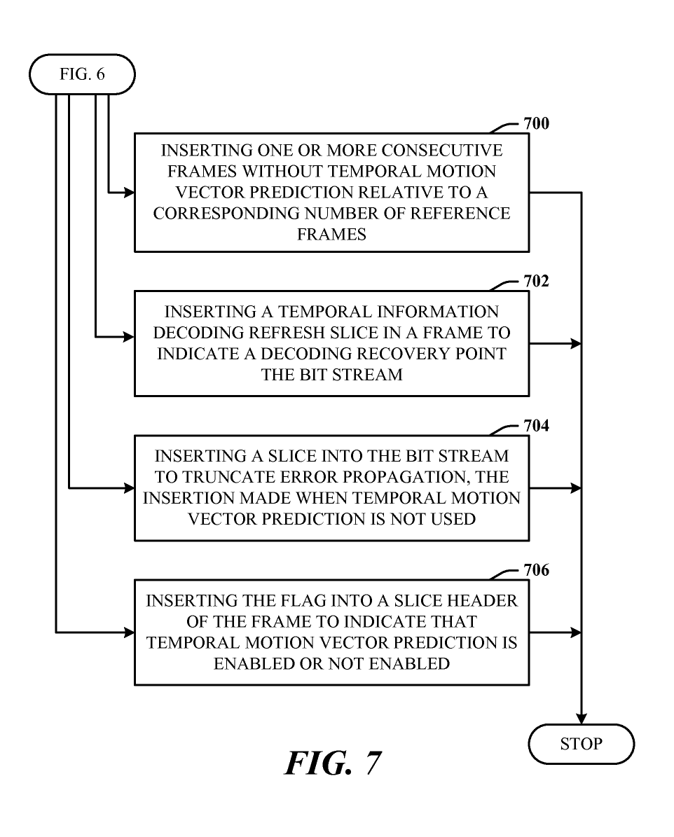

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, one or more consecutive frames are inserted without temporal motion vector prediction relative to a corresponding number of reference frames. At 702, a temporal information decoding refresh slice is inserted in a frame to indicate a decoding recovery point the bit stream. At 704, a slice is inserted into the bit stream to truncate error propagation, the insertion made when temporal motion vector prediction is not used. At 706, the flag is inserted into a slice header of the frame to indicate that temporal motion vector prediction is enabled or not enabled.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

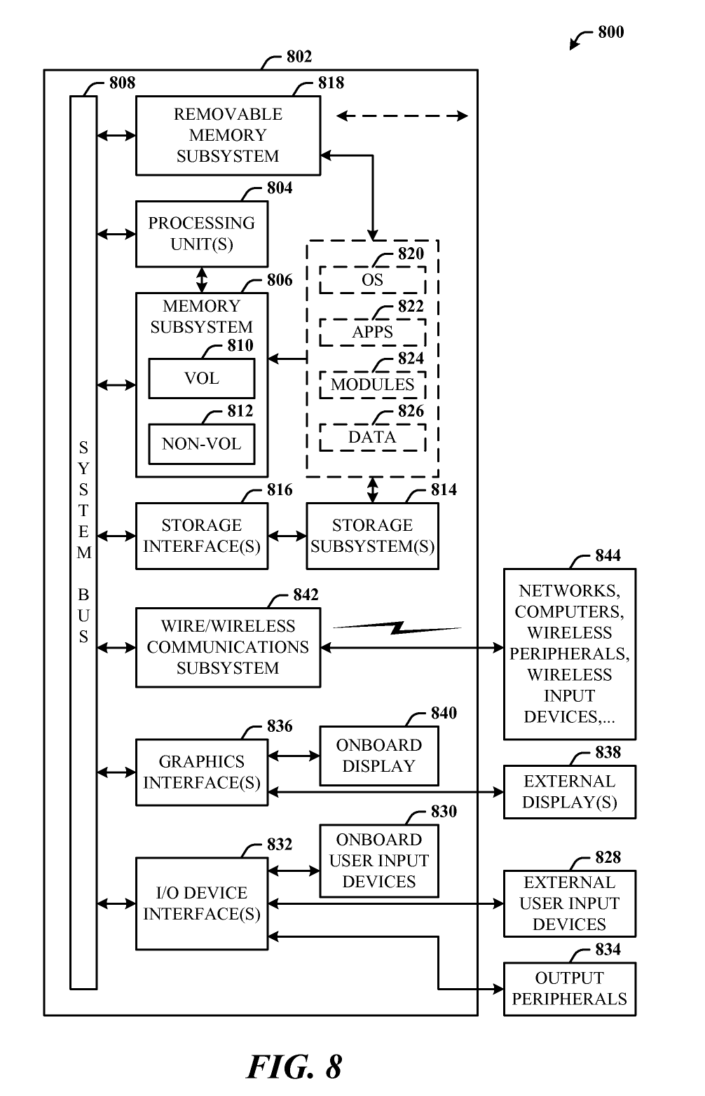

Referring now to FIG. 8, there is illustrated a block diagram of a computing system 800 that can execute motion vector prediction in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include the entities and components of the system 100 of FIG. 1, the entities and components of the system 200 of FIG. 2, the sequence 300 of FIG. 3, the entities and flow of the system 400 of FIG. 4, the solution 500 of FIG. 5, and the methods represented by the flowcharts of FIGS. 6 and 7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A video error correction system, comprising:
a video encoder component that encodes a sequence of video frames as syntax elements in a bit stream; and
a flag component that employs and operates a flag in a video frame to manage error correction via a motion vector.

2. The system of claim 1, wherein the motion vector is a temporal motion vector for temporal motion vector prediction.

3. The system of claim 2, wherein the flag component inserts into and operates the flag in a frame header to indicate that temporal motion vector prediction is enabled or not enabled.

4. The system of claim 1, wherein the flag is signaled in a parameter set to enable a sequence to use temporal motion vector prediction.

5. The system of claim 1, wherein the flag component inserts the flag into a frame header to indicate that prediction for a specific list is enabled or not enabled.

6. The system of claim 1, wherein the video encoder component encodes an entire index of a motion vector that is a temporal motion vector predictor.

7. The system of claim 1, further comprising a decoder component that processes the flag and inserts slices to reduce errors when decoding the bit stream.

8. The system of claim 7, the decoder component tags all reference frames, except a current temporal information decoding refresh (TIDR) frame, as unused for temporal syntax element prediction, the tags applied to reference frames immediately before decoding of a first frame following the current TIDR, or the tags applied to reference frames immediately before decoding of a first frame following the current TIDR with an output order greater than the current TIDR frame.

9. The system of claim 1, further comprising an insertion component that inserts a slice into the bit stream to truncate error propagation, the insertion made when temporal motion vector prediction is not used.

10. The system of claim 9, wherein the insertion component inserts temporal information decoding refresh slices in a frame to provide a decoding recovery point in the bit stream.

11. The system of claim 9, wherein the insertion component inserts a number of frames without temporal motion vector prediction, the number correlates to a number of reference frames employed.

12. A video error correction system, comprising:
a video encoder component that encodes a sequence of video frames as a bit stream;
an insertion component that optionally inserts a slice into the bit stream to truncate error propagation;
a flag component that employs and operates a flag in the slice to manage error correction via a motion vector; and
a decoder component that processes the flag and inserted slice to reduce errors when decoding the bit stream.

13. The system of claim 12, wherein the motion vector is a temporal motion vector for temporal motion vector prediction and the flag component operates the flag in a slice header of the slice to indicate that temporal motion vector prediction is enabled.

14. The system of claim 12, wherein the flag component employs a flag in a frame header to indicate that list prediction is enabled.

15. The system of claim 12, wherein the insertion component inserts a slice when temporal motion vector prediction is not used, and a temporal information decoding refresh slice in a frame to provide a decoding recovery point in the bit stream.

16. A video error correction method, comprising acts of:
performing motion vector encoding of video frames in a bit stream;
inserting a flag in a video frame to indicate if a temporal motion vector prediction is being employed in the frame; and
decoding the flag to reduce error correction.

17. The method of claim 16, further comprising inserting one or more consecutive frames without temporal motion vector prediction relative to a corresponding number of reference frames.

18. The method of claim 16, further comprising inserting a temporal information decoding refresh slice in a frame to indicate a decoding recovery point the bit stream.

19. The method of claim 16, further comprising inserting a slice into the bit stream to truncate error propagation, the insertion made when temporal motion vector prediction is not used.

20. The method of claim 16, further comprising inserting the flag into a slice header of the frame to indicate that temporal motion vector prediction is enabled or not enabled.
